(19) United States
(12) Patent Application Publication
(10) Pub. No.: US 2010/0206811 A1
(43) Pub. Date: Aug. 19, 2010

(54) POLYMERIC MEMBRANES INCORPORATING NANOTUBES

(75) Inventors: How Yong Ng, Singapore (SG); Wei Duan, Singapore (SG)

Correspondence Address: INTELLECTUAL PROPERTY / TECHNOLOGY LAW, PO BOX 14329, RESEARCH TRIANGLE PARK, NC, 27709, US

(73) Assignee: NATIONAL UNIVERSITY OF SINGAPORE, Singapore (SG)

(21) Appl. No.: 12/677,299

(22) PCT Filed: Sep. 10, 2008
(86) PCT No.: PCT/SG2008/000340

§ 371 Date: Apr. 13, 2010

Related U.S. Application Data
(60) Provisional application No. 60/971,124, filed on Sep. 10, 2007.

(51) Int. Cl. B01D 69/00; B28B 1/14; B05D 1/36; B32B 3/10; B01D 61/02; B01D 71/00; B01D 67/00

(52) U.S. Cl. 210/654; 264/299; 427/258; 210/500.21; 210/500.38; 210/490; 210/500.23

(57) ABSTRACT

The present invention relates to semipermeable membranes with nanotubes dispersed therein, and the methods of preparing the same.

### CROSS-REFERENCE TO RELATED APPLICATIONS

This application claims the benefit of priority of U.S. provisional application No. 60/971,124, filed Sep. 10, 2007, the content of which is hereby incorporated by reference in its entirety for all purposes.

### FIELD OF THE INVENTION

The present invention relates to semipermeable membranes with nanotubes dispersed therein, and the methods of preparing the same.

### BACKGROUND OF THE INVENTION

Polymeric membranes have been widely adopted for liquid separation in a wide range of industries including pharmaceutical, food and water. Recently, reverse osmosis (RO) and forward osmosis (FO) processes have been increasingly used for such liquid separation. The basic concept underlying those membrane separation processes is the well known process of osmosis.

Osmosis is defined as the net movement of water across a selectively permeable membrane driven by a difference in osmotic pressure across the membrane. A selectively permeable membrane allows passage of water (H₂O), but rejects solute molecules or ions. Osmotic pressure (π) is the pressure which, if applied to the more concentrated solution, would prevent transport of water across the membrane.

In a reverse osmosis (RO) process, a predetermined pressure is applied to incoming water (feed solution) to force the incoming water through a semipermeable membrane. Thus, in RO, the applied pressure is the driving force for mass transport through the membrane; in osmosis, the osmotic pressure itself is the driving force for mass transport.

The semipermeable membrane filters the impurities from the incoming water (feed solution) leaving purified water on the other side (permeate side) of the membrane called permeate water. The impurities left on the membrane are washed away by a portion of the incoming water that does not pass through the membrane. The feed solution carrying the impurities washed away from the membrane is also called “reject” or “brine”. RO processes have been widely used for example in industrial water treatment, sea water desalination, water reclamation from brackish or treated used water. (Cath, T. Y., Childress, A. E., Elimelech, M., 2006, Journal of Membrane Science, vol. 281, p. 70-87).

In recent years, forward osmosis (FO) processes have been developed as a possible alternative membrane technology for water treatment due to the low energy requirement as a result of low or no hydraulic pressures applied, high rejection of a wide range of contaminants, and low membrane fouling propensity compared to pressure-driven membrane processes, such as reverse osmosis (RO). FO uses the osmotic pressure differential (Δπ) across the membrane, rather than hydraulic pressure differential (as in RO), as the driving force for transport of water through the membrane. The FO process results in concentration of a feed stream and dilution of a highly concentrated stream (referred to as the draw solution). In other words, the FO process utilizes the natural osmosis phenomenon, which makes use of concentration differences between two solutions across a semipermeable membrane. The semipermeable membrane acts as a selective barrier between the two solutions, and dominates the efficiency of freshwater transportation in the FO process.

In a FO process, a concentrated solution on the permeate side of the membrane is the source of the driving force in the FO process. Different terms are used in the literature to name this solution including draw solution, osmotic agent, or osmotic media to name only a few. In a FO process the draw solution has a higher osmotic pressure than the feed solution (or reject or brine). Examples for such osmotic agents are MgCl₂, CaCl₂, NaCl, KCl, sucrose, MgSO₄, KNO₃ and NH₄HCO₃ (wherein the osmotic pressure is the highest for MgCl₂ and the lowest for NH₄HCO₃).

Currently, the semipermeable membranes used for such separation processes are polymer based. Usually, the RO membranes have a dense selective layer embedded onto a support layer for providing rejection of dissolved compounds and providing mechanical strength respectively.

Generally, the performance of a reverse osmosis membrane is expressed by two values, a flux representing the amount of water that permeates a unit area of the membrane in a unit time, and a rejection (solute rejection) representing the degree to which the permeation of a solute through the membrane can be inhibited. The performance of the reverse osmosis membrane is governed by the membrane material, and the flux and the rejection are balanced in that performance. In other words, when the membrane-fabrication conditions are varied to increase the flux of the membrane, its rejection decreases; when the rejection is increased, on the other hand, the flux decreases.

Therefore, it is desirable to further improve the performance of such semipermeable membranes which can be used, e.g., in RO and FO processes.

### SUMMARY OF INVENTION

In one aspect, the present invention provides a method of manufacturing a semipermeable membrane, wherein the method comprises dispersing nanotubes in a polymer solution to obtain a nanotube-polymer dispersion; casting a membrane having an upper and lower surface with said dispersion by phase inversion method; and wherein the nanotubes can be added to said polymer solution in a concentration of nanotubes to polymer in said polymer solution that substantially avoids formation of nanotube structures that extend along the entire thickness of the membrane between said upper and said lower surface.

In another aspect, the present invention provides a method of manufacturing a composite semipermeable membrane, wherein the method comprises providing a polyfunctional amine solution on a substrate to form a polyfunctional amine layer on the substrate; providing a polyfunctional acid halide solution; and bringing the polyfunctional acid halide solution into contact with the polyfunctional amine layer to form a polyamide film having an upper and a lower surface; wherein nanotubes can be dispersed either in the polyfunctional amine solution or in the polyfunctional acid halide solution or in both solutions before bringing the solutions into contact with each other; wherein the nanotubes can be added to the solution in a concentration that substantially avoids formation of nanotube structures that extend along the entire thickness of the polyamide film between the upper and the lower surface.

In another aspect the present invention provides a method of manufacturing a polymeric semipermeable membrane, wherein said method comprises dispersing nanotubes in a polymer solution to obtain a nanotube-polymer dispersion; and casting a membrane having an upper and lower surface with said dispersion by phase inversion method; wherein said nanotubes are added to said polymer solution in a concentration of nanotubes to polymer in said polymer solution between about 0.001 to about 10 wt. %.

In still another aspect, the present invention provides a method of manufacturing a composite semipermeable membrane, wherein the method comprises providing a polyfunctional amine solution on a substrate to form a polyfunctional amine layer; providing a polyfunctional acid halide solution; and bringing the polyfunctional acid halide solution into contact with the polyfunctional amine layer to form a polyamide film having an upper and a lower surface; wherein nanotubes can be dispersed either in the polyfunctional amine solution or in the polyfunctional acid halide solution or in both solutions before bringing the solutions into contact with each other; wherein the nanotubes can be added to the solution(s) in a concentration between about 0.001 to about 10 wt. %

According to another aspect, the present invention provides a polymeric semipermeable membrane comprising an upper and lower surface; wherein the membrane comprises nanotubes dispersed therein, wherein the nanotubes do not extend along the entire thickness of said membrane between said upper and said lower surface.

The present invention also provides a composite semipermeable membrane comprising a polyamide film having an upper and lower surface; wherein the polyamide film comprises nanotubes dispersed therein, wherein the nanotubes do not extend along the entire thickness of the polyamide film between the upper and the lower surface; the polyamide film being arranged on a substrate.

The present invention also provides a use of semipermeable membranes obtained by a method of the present invention, or semipermeable membranes of the present invention for the separation of H₂O from solute molecules.

### BRIEF DESCRIPTION OF DRAWINGS

The invention will be better understood with reference to the detailed description when considered in conjunction with the non-limiting examples and the accompanying drawings.

FIG. 1 shows a schematic diagram illustrating an FO membrane (1) formed by phase inversion method. The rod like structures (12) which can be seen within the membrane (1) symbolize the nanotubes (12) dispersed in the polymer membrane (1). The skin layer (10) is a remnant of the polymerization reaction as one can find it on the upper surface of the membrane (1) formed after a polymerization reaction based on phase inversion.

FIG. 2 shows a schematic diagram illustrating Type 1 RO membrane (2) formed by phase inversion method on a support layer (14). The rod like structures (12) which can be seen within the membrane (2) symbolize the nanotubes (12) dispersed in the polymer membrane (2). The skin layer (10) is a remnant of the polymerization reaction as one can find it on the upper surface of the membrane (2) formed after a polymerization reaction.

FIG. 3 shows a schematic diagram illustrating Type 2 RO membrane (3) formed by interfacial polymerization method cast on a substrate (16) with a support layer (14). The rod like structures (12) which can be seen within the polymer film (18) symbolize the nanotubes (12) dispersed in the polymer film (18).

FIG. 4 shows a schematic diagram illustrating a prior art RO membrane made by interfacial polymerization reaction having a polyamide film (18) formed on a microporous substrate (16). The substrate reinforced on a support layer (14).

FIG. 5 shows a graph illustrating the flux and rejection capability with different nanotube contents in a FO membrane in comparison to the prior art membrane. In the graph, X axis representing weight percentage content of Carbon Nanotubes to polymer (CA) used and Y-axis represents flux in gallons per square foot (GFD) of membrane per day and rejection percentage. In one example for testing the membrane capabilities, sodium chloride (NaCl) having a concentration of 2.0 M can be used as draw solution whereas pure water was used as feed solution. The cross-flow rate was about 2 L/min; and the temperature was about 25° C. for both draw and feed solutions.

FIG. 6 shows a graph illustrating the flux and rejection capability with different nanotube contents in a FO Membrane in comparison to the prior art membrane. In the graph, X axis representing weight percentage content of Carbon Nanotubes to polymer (CA) used and Y-axis represents flux in (m³ m⁻² s⁻¹) and rejection percentage. In one example for testing the membrane capabilities, sodium chloride (NaCl) having a concentration of 2.0 M can be used as draw solution whereas pure water was used as feed solution. The cross-flow rate was about 2 L/min; and the temperature was about 25° C. for both draw and feed solutions.

FIG. 7 shows a graph illustrating mechanical strength of the cellulose acetate (CA)/Multiwalled nanotube (MWNT) FO membranes with different MWNT contents X axis representing weight percentage content of Carbon Nanotubes to polymer (CA) used and Y-axis represents breaking strength in (MPa).

FIG. 8 shows a schematic diagram of the laboratory-scale setup for testing a FO membrane.

FIG. 9 shows a schematic diagram of the laboratory-scale setup for testing a RO membrane.

FIG. 10 shows a graph illustrating the effect of MWNT on the surface properties of CA/MWNT FO membranes. X-axis representing weight percentage of MWNT content to polymer (CA) used and Y-axis represents Surface (Zeta) potential (mV) or Roughness (nm) and Contact angle) (°)

FIG. 11 a graph illustrating thermogravimetric analysis (TGA) curves of the CA/MWNT FO polymeric membranes with different weight percentage of MWNT content to polymer (CA). X axis represents temperature (° C.) and Y-axis represents weight loss (%).

FIG. 12 shows the X-ray Diffraction patterns of cellulose acetate membrane, cellulose acetate/MWNT membrane, and MWNT as such.

FIG. 13 (a to c) shows the transmission electron microscopy (TEM) images illustrating the distribution of MWNT in a cellulose acetate membrane at different MWNT concentrations, namely 0.2 wt % (a) and (b) and 3 wt % (c).

### DETAILED DESCRIPTION OF THE INVENTION

The present invention provides polymeric or composite semipermeable membranes with nanotubes dispersed therein suitable for separation of water (H₂O) from solutes, methods of manufacturing these membranes and their use.

A semipermeable membrane means a membrane allowing only certain molecules or ions to pass through it by diffusion. The rate of passage depends on the pressure, concentration, and temperature of the molecules or solutes on either side, as well as the permeability of the membrane to each solute.

The membranes known for use in the reverse osmosis (RO) or forward osmosis (FO) processes are for example cellulose based polymeric membranes and thin film composite membranes. The composite membranes used for such RO and FO processes are semipermeable membranes having chemically or structurally different layers.

Typically, a composite membrane comprise a solute-rejecting dense layer placed on a porous support. The general set up of such composite membrane is known in the art as for example described by (Cath, T. Y., Childress, A. E., Elimelech, M., 2006, supra). These membranes are asymmetric membranes where the dense layer of the membrane decides the separation performance and a microporous layer reinforces the dense layer.

The cellulose based polymeric semipermeable membranes can be prepared by known phase inversion methods where the dense layer and the microporous layer reinforcing the dense layer are made up of the same material.

According to one example, the present invention provides a method for manufacturing a polymeric or composite semipermeable membrane by dispersing nanotubes in a polymer solution to obtain a nanotube-polymer dispersion and casting a membrane having an upper and lower surface with the dispersion by phase inversion method. The nanotubes are added to the polymer solution in a concentration of nanotubes to polymer in said polymer solution that avoids formation of nanotube structures that extend along the entire thickness of the membrane between the upper and the lower surface.

The polymer solution may be prepared by mixing a polymer in a suitable solvent. The polymers suitable for preparing the membrane may include cellulose based polymers. In general, the polymer to solvent ratio can be for example about 15/80, 15/75, 15/70, 18/75, 18/80, 18/70, 20/70, 20/75, or 20/80.

The cellulose-based polymers may be, for example, cellulose derivates including cellulose acetate, cellulose nitrate, cellulose diacetate, cellulose triacetate (CTA), cellulose butyrate, cellulose proprionate, cellulose acetate propionate (CAP), cellulose acetate butyrate (CAB) and cellulose tributyrate (CTB) and mixtures thereof.

The concentration of polymer in the polymer solution depends on the polymer used. In general, the concentration of the polymer in said solution can be between about 10 to about 40 wt %. A person skilled in the art could choose a suitable polymer concentration depending on the polymer used. For example, for cellulose acetate, a concentration may be in the range of about 18 to 30 wt % while for cellulose triacetate, the concentration can be between about 10 to 15 wt %.

Dispersing nanotubes in a polymer matrix improves the performance of the membranes. The dispersion of nanotubes in the polymer solution is such that, on casting the nanotube-polymer dispersion, the nanotube structures formed in the membrane do not extend along the entire thickness of membrane between upper and lower surface of the membrane. Without being bound by theory, it is assumed that tube-tube contacts may be formed which connect the nanotube ends in the polymer matrix so that water can be transported through the nanotubes at high velocity.

Dispersion of the nanotubes in a membrane can be varied by adapting the concentration of the nanotubes in a polymer solution (such as cellulose based polymers or polyfunctional acid halides). In an example, the concentration of nanotubes to a polymer in the polymer solution may be in a concentration between about 0.001 to about 10 wt %.

In another example, the concentration of nanotubes to polymer in the polymer solution may be between 0.01 to about 10 wt %, or between about 0.1 to about 0.5 wt %, or between about 0.2 to about 0.4 wt %, or about 0.2 to about 0.3 wt %.

In another example, the concentration of nanotubes to polymer in the polymer solution may be between 0.01 to about 10 wt %, or between about 0.1 to about 0.5 wt %, or between about 0.2 to about 0.4 wt %, or about 0.2 to about 0.3 wt % for FO membranes.

In another example, the concentration of nanotubes to polymer in the polymer solution may be between 0.01 to about 10 wt %, or between about 0.1 to about 0.5 wt %, or between about 0.2 to about 0.4 wt %, or about 0.2 to about 0.3 wt % for Type 1 RO membranes.

This results in a nanotube content in the polymer solution (comprising of polymer, solvents, and nanotube) which is almost less than 5 wt %, or 4 wt %, or 2 wt %.

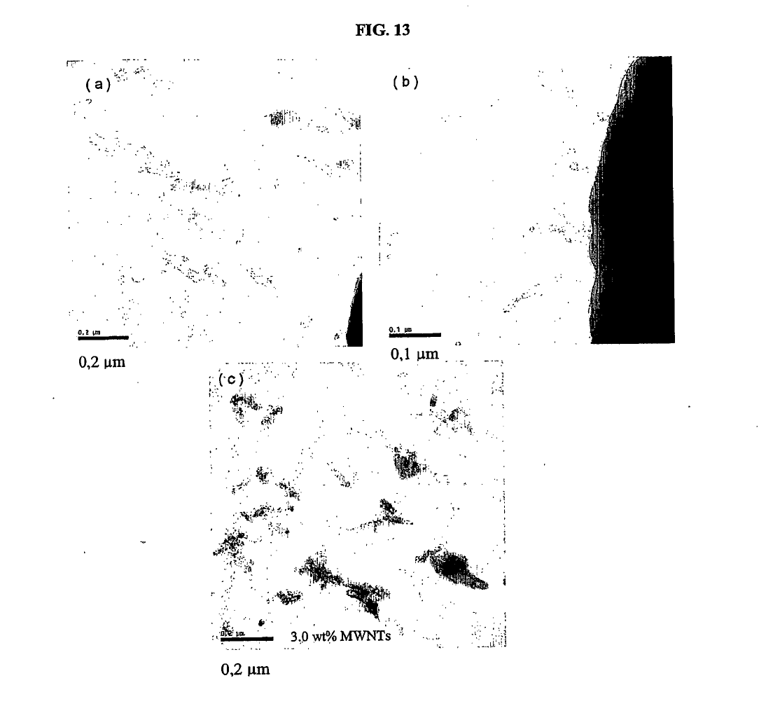

The concentration of the nanotubes to polymer in the polymer solution can affect the formation of nanotube structures within the membrane. At the nanotube concentrations specified herein the nanotube structures (single or interconnected nanotubes) formed within the membrane do not extend along the entire thickness of the membrane between the upper and the lower surface of the membranes of the present invention. FIG. 13 (a and b) shows the formation of nanotube structures at such concentrations that do not extend along the entire thickness of the membrane. Nanotube structures extending over the entire thickness of the membrane result in a decreased solute rejection capability of the membrane.

It was found by the inventors, when the nanotubes are not dispersed well in the polymer matrix, it may result in nanotubes which cluster or aggregate. Aggregation and clustering can have an effect on the membrane performance. FIG. 13 (c) shows the formation of such aggregates or clusters at a higher nanotube concentration. Therefore, when using higher concentration of nanotubes, the nanotubes can be dispersed using dispersing agents.

It has been found by the inventors that the dispersion of nanotubes influence the pore size of the membrane. When the nanotubes are well dispersed in the membranes, membranes with smaller pore size can be formed which increases the permeability of the membrane and also has a positive effect on rejection of solutes. However, the inventors found that at higher nanotube concentration, (4 wt %) the formation of large pores on the membrane surface caused by nanotube aggregation resulted in a slight decline in solute rejection.

The nanotubes may be selected from the group consisting of single-walled nanotubes (SWNT), multiwalled nanotubes (MWNT), or modified multiwalled nanotubes. The SWNT is a seamless cylinder formed from one graphite layer. Multi-walled nanotubes (MWNT) consist of multiple layers of graphite rolled in on to form a tube shape. The nanotubes may be modified to have hydrophilic groups such as hydroxyl group, pyrenes, esters, thiols, amines, a carboxyl group and mixtures thereof on their surface.

The nanotubes can be made for example of carbon material, a ceramic glass, such as soda-lime glass, acrylic glass, is in glass (Muscovy glass), aluminium oxynitride; a metal, a metal oxide, a polypyrrole and mixtures of nanotube materials made of different of the aforementioned substances. In another example, the nanotubes are made of a carbon material.

In an illustrative example, the nanotubes may be hydrophobic or may be treated to carry hydrophilic groups. Nanotubes as manufactured are hydrophobic In the context of the present invention, hydrophilic nanotubes or nanotubes carrying hydrophilic groups means that they have been subjected to a specific treatment to introduce such hydrophilic groups on the surface of the nanotubes.

Examples for such treatments are sintering at temperatures <500° C., refluxing in inorganic polar solvents (oxidative treatment), such as HNO₃ or H₂SO₄ or HCl or mixtures of such inorganic polar solvents for 24 h; or plasma treatment, such as N₂ or H₂ or O₂ plasma treatment.

According to one example, the nanotubes may be modified having hydrophilic groups such as hydroxyl group, pyrenes, esters, thiols, amines, a carboxyl group and mixtures thereof on their surface. As the unmodified nanotubes, the modified nanotubes are dispersed in the cast solution. In one illustrative example, the nanotubes are modified having hydroxyl groups on their surface.

To increase the water transport across the membrane, the nanotubes may have both ends open which means that the tube has an inlet opening and an outlet opening. The inner diameter of the nanotubes may be for example in the range of from about 2 to about 6 nm, from about 3 to about 6 nm, from about 4 to about 6 nm, from about 4 to about 5 nm, from about 3 to about 5 nm.

The nanotubes may be chosen such that the length of the nanotubes does not go through the whole membrane thickness, i.e. that it does not span the entire width of the membrane. To ensure that this can also be the fact for very thin membranes such as some membranes employed in FO processes, the length of the nanotubes can be adapted such as to ensure that the length of the nanotube is shorter than the width of the membrane. Thus, the length of the nanotubes may be varied depending upon the thickness of the membrane to be formed. In one example, the nanotubes may be of short length from about 0.2 to about 4 μm in length or 0.5 to about 3 μm, or 1 μm to about 4 μm.

Furthermore, nanotubes with short length usually disperse well and hence avoid formation of tube connections that extend between the upper and lower surface of the membrane.

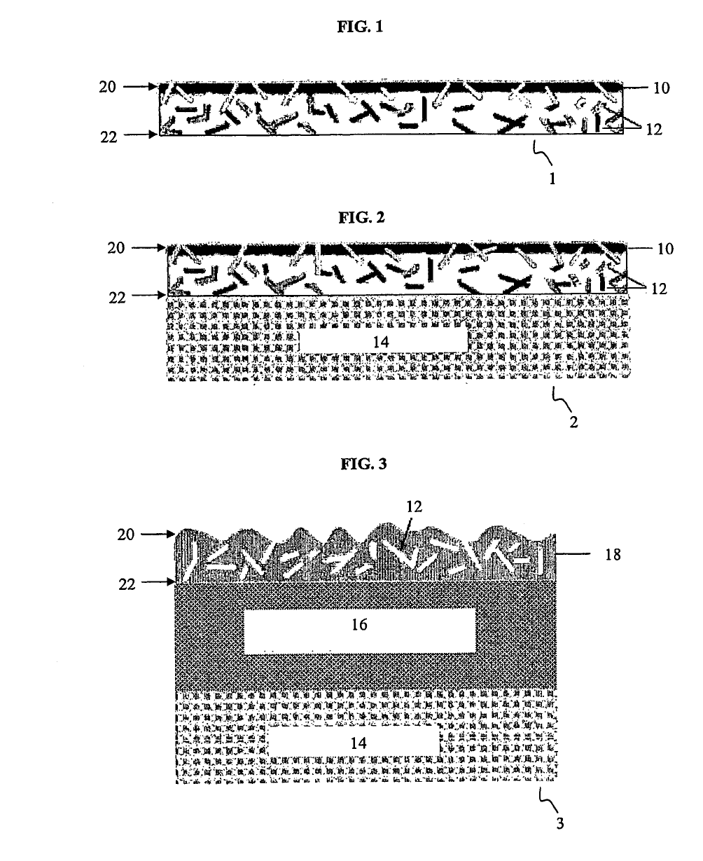

In one example, the nanotubes are subjected to a mechanical pre-treatment, for example high-pressure ball mill, in which the length of the nanotubes is shortened to about 0.2 to about 4 μm, such as the nanotubes available from Chengdu Organic Chemicals Co., Ltd., Chinese Academy of Sciences. While shortening the length of the nanotubes, it is ensured that both ends of the nanotubes are open to allow liquid flow through the nanotube. Thus, the water transport across the membrane is increased. In case nanotubes interconnect within the membrane, small passageways can be formed which accelerate the flux rate through the membrane which otherwise takes place exclusively by diffusion (see e.g. FIGS. 1 to 3).

Thus, avoiding that the nanotubes span over the entire membrane thickness or form interconnected membrane structures spanning the entire membrane thickness, such as hollow tube sections connected to each other to form a pipeline, has the advantage that the solute rejection capability is maintained unlike for example in Choi, J.-H., Jegal, J., Kim, W.-N. (2006, Journal of Membrane Science, vol. 284, p. 406). While maintaining the solute rejection capability of the semipermeable membrane of the present invention the flux rate is increased at the same time due to the fact that water can not only pass over the membrane by diffusion but can skip short distances within the membrane by flowing through the hollow nanotube structure.

Further, the inventors also found that the concentration of the nanotubes can also influence the membrane surface roughness. It was found that the surface roughness and the surface potential decreased with addition of nanotubes. The membranes become smoother and more negatively charged with the addition of nanotubes which can be beneficial for improved water permeability and salt rejection.

In one embodiment, dispersing nanotubes in a polymer solution can be achieved by adding a predetermined quantity of nanotubes in a solvent and then dispersing the nanotubes by using known methods, such as sonication. Sonication can be carried out, for example, by using an ultrasonic bath or high-power sonic tip dispersion. Afterwards, a predetermined quantity of polymer can be added to the solution containing the dispersed nanotubes forming a polymer/nanotube dispersion. The predetermined quantity of nanotubes and predetermined quantity of a polymer can be determined by a person skilled in the art depending on the desired weight ratio of nanotubes to a polymer to be achieved.

Sonication can be carried out from about 5 min to about 1 hour or about 10 min to about 45 min or about 10 min to about 35 min. The nanotube-polymer dispersion thus formed can be kept stable to remove air bubbles from the solution for about 12 to 24 hours before casting the membrane.

In another example, dispersing nanotubes in a polymer solution to obtain a polymer-nanotube dispersion may be achieved by combining a quantity of nanotubes with a surfactant to form a surfactant-nanotube mixture. Subsequently, the surfactant-nanotube mixture can be sonicated. Adding a surfactant can enhance dispersability of the nanotubes. Afterwards, the surfactant-nanotube mixture is dissolved in a solvent to obtain a nanotube solution. Optionally, this nanotube solution can be sonicated for a suitable time. To this solution a predetermined quantity of polymer is added to form a dispersed polymer-surfactant-nanotube dispersion. Optionally, the nanotube-surfactant-polymer dispersion thus formed is kept stable to remove air bubbles from the solution for about 12 to 24 hours before casting the membrane.

In another example, dispersing nanotubes in a polymer solution may also be achieved by preparing a polymer solution and adding a predetermined quantity of nanotubes to the polymer solution and mixing and stirring the polymer solution to form a polymer-nanotube dispersion. Optionally, the solution can be sonicated several times for about 10 to 30 min.

The solvent used for the preparation of the polymer solution can be an organic solvent. The solvent can be, for example, acetic acid, dioxane, chloroform, formamide, benzene, ethanol, methanol, isopropyl alcohol, alcohols having ≦4 carbon atoms, and combinations thereof.

Any known solvent can be used to disperse nanotubes to form a nanotube dispersion, such as water or an organic solvent. Examples for organic solvents can be acetone, formamide, or mixtures thereof.

According to one example, casting the membrane having an upper and lower surface with the nanotube-polymer dispersion can be done by phase inversion method.

Phase inversion method is well known for the preparation of membranes. Solvent phase inversion involves the making of a solution of the polymer to become the membrane, forming the dissolved polymer into a desired shape, and exposing the solution to a non-solvent of the polymer to cause the polymer to precipitate from solution and form a membrane in the desired shape. In the case of nylon membranes, one skilled in the art can refer to U.S. Pat. No. 5,006,247.

Casting the membrane involves pouring the polymer/nanotube dispersion onto a surface, such as a smooth surface, and then allowing to form a membrane by phase inversion method. For example, Choi, J.-H., Jegal, J., Kim, W.-N. (2006, supra) disclose casting of polysulfone membranes by phase inversion method.

In one method, the nanotube-polymer dispersion can be cast on a smooth surface such as for example glass, stainless steel, aluminium, aluminium alloy, iron, plastics such as Polytetrafluoro ethylene (PTFE), Polypropylene (PP), Polyethylene (PE), PolyvinylChloride (PVC), Acrylonitrile Butadiene Styrene (ABS), Polyamide (PA), polyoxymethylene (POM), polycarbonate (PC), polyphenylene oxide (PPO), Polyester (PET), Polyethylene terephthalate (PETE).

The cast is then immersed in a coagulation bath containing a solvent. The membrane is then annealed for prescribed period of time.

The coagulation bath may contain water or mixture of water and an additive as a solvent. The additive can be, for example, acetone, acetic acid, dioxane, chloroform, formamide, benzene, ethanol, methanol, isopropyl alcohol, alcohols having 54 carbon atoms, and combinations thereof. The coagulation bath can be kept at a temperature of about 0° C. to about 7° C. In another example, the temperature is kept from about 0° C. to about 4° C.

In one example, the support on which the cast solution is cast may be immersed in the coagulation bath after evaporating the solvent for a prescribed time. In this case, the time for evaporating the solvent may be between about 0 to about 60 min. In one example, the evaporating time may be between about 0 to about 10 min, about 0 to about 6 min.

The annealing process for curing the membrane may be carried out between about 50° C. to about 90° C., about 60° C. to about 80° C. Annealing process can be carried out for about 10 to about 60 min.

Furthermore, the present invention also refers to a composite or polymeric semipermeable membrane. The composite semipermeable membrane comprises an upper and lower surface; wherein the membrane comprises nanotubes dispersed therein. The nanotubes dispersed therein do not extend along the entire thickness of the membrane between the upper and the lower surface.

In general, cellulosic reverse osmosis membranes have a peculiar “skin” also called skin layer or a dense selective layer having selective effective (for preventing the passage of unwanted dissolved salts through the membrane while simultaneously permitting such passage of purified water) porosity formed at the upper surface of the membrane. This skin is sometimes termed the “active” layer; the remainder of the membrane usually is very porous, with increasing porosity occurring as one proceeds in the direction through the membrane away from the “active” layer. It is apparently this special skin that endows these specific membranes with their valuable selective nature.

FIG. 1 shows for example a FO membrane in which the rod like structures (12) which can be seen within the membrane (1) between the upper (20) and lower surface (22) symbolize the nanotubes (12) dispersed in the polymer membrane (1). The skin layer (10) is a remnant of the polymerization reaction as one can find it on the upper surface (20) of the membrane (1) formed after a polymerization reaction based on phase inversion.

The semipermeable membrane thus fabricated according to a method of the present invention as described above, has an asymmetric structure along the cross-sectional direction and a thickness between about 10 to about 400 μm, or 10 to 200 μm or 20 to 100 μm. The semipermeable membrane of the present invention can have a thickness between about 40 to 80 μm, about 50 μm to about 80 μm, about 60 to about 80 μm.

In one example, a semipermeable membrane fabricated according to a method of the present invention as described above is a FO membrane.

Incorporating nanotubes also enhance the mechanical strength of the membrane. Without wishing to be bound by theory it is proposed that the addition of nanotubes led to increase in viscosity of the casting solution. This resulted in the formation of thicker dense selective layer and the suppression of the formation of macrovoids which may contribute to the improvements in the mechanical strength of the semipermeable membrane with nanotubes incorporated or entrained therein. In addition, the nanotubes can function like small fibers trapped in membrane to reinforce the membrane strength.

It is also proposed that the composite semipermeable membrane having nanotubes incorporated or entrained therein show an improvement in water permeability without any reduction in solute rejection. In some examples, it is also possible that water permeability and solute rejection increases in comparison to the prior art membrane. The inventors found that in some examples the thicker dense selective layer of the composite semipermeable membrane formed due to incorporation of nanotubes increased solute rejection.

According to one example, the membrane is cast on a support layer. The support layer provides additional mechanical strength to withstand such a high pressure. When the membranes of the present invention are to be operated on a predetermined pressure, for example in RO processes where the membranes are subjected to high pressure, the membranes may have to withstand applied pressure. The membranes may be cast on a support layer.

The support layers according to an illustrative example, can be for example, a woven fabric or a non-woven fabric. The woven or the non-woven fabric can be for example made of a material selected from the group consisting of polyesters, polypropylenes, polyamides, polyacrylonitriles, regenerated celluloses and acetyl-celluloses.

FIG. 2, for example shows for example such a Type 1 RO membrane cast on a support layer. In one example, a method of the present invention as described above provides a Type 1 RO membrane where the semipermeable membrane is cast on a support layer.

In example, the stability of FO membranes may be increased by optionally casting the FO membranes on a support layer. (Cath, T. Y., Childress, A. E., Elimelech, M., 2006, Journal of Membrane Science, vol. 281, p. 70-87). The support layer can be, for example, a polymer mesh. The polymer mesh for example may be made of polyesters, polypropylenes, polyamides, polyacrylonitriles, regenerated celluloses and acetyl-celluloses. The polymer mesh may have a thickness of less than 50 μm or 40 μm or 30 μm or 20 μm.

Thus, the present invention provides a composite semipermeable membrane arranged on a support layer. The semipermeable membrane of the present invention has an asymmetric structure along the cross sectional direction. The semipermeable membrane thus fabricated on a support layer using the method of the present invention as described above where the semipermeable membrane has a thickness between about 4 to 200 μm when used for FO processes. The semipermeable membrane of the present invention for example Type 1 RO membrane can have a thickness between about 80 to 250 μm.

According to another example, the present invention provides a method of manufacturing a composite semipermeable membrane by interfacial condensation method. Interfacial polycondensation processes are well known for preparing composite semipermeable membranes where copolymerization or condensation of polyfunctional amine solution and a polyfunctional acid halide solution takes place at interface between the two solutions resulting in the formation of thin film. For example, composite polyethylenimine film, coated on a porous support such as polysulfone, with a polyfunctional crosslinking agent such as isophthaloyl chloride (U.S. Pat. No. 4,039,440).

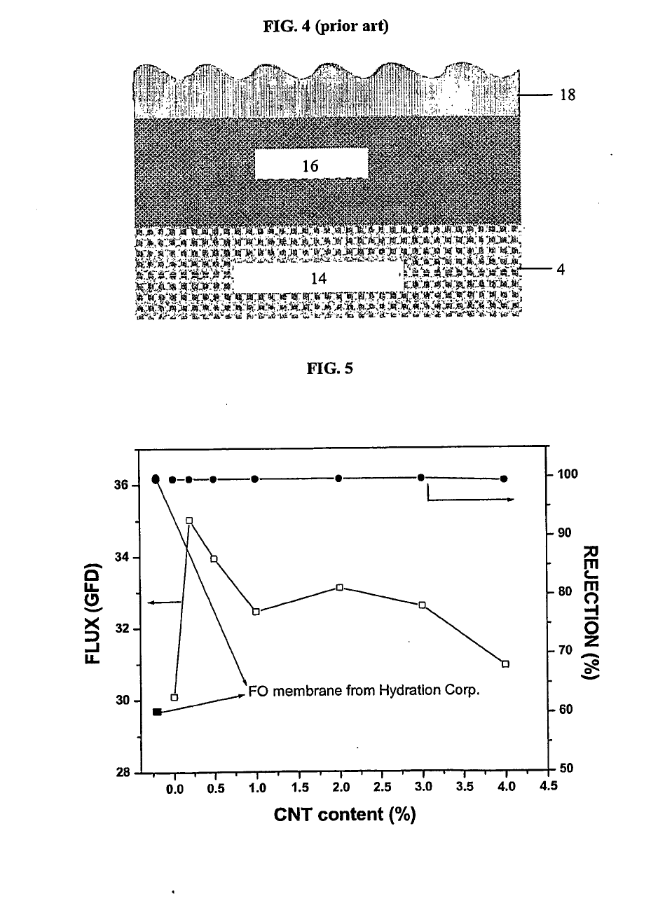

FIG. 4 shows the structure of a prior art RO membrane made by interfacial polymerization reaction having a polyamide film (18) formed on a microporous substrate (16). The substrate reinforced on a support layer (14).

In one example, the present invention provides a method of manufacturing a composite semipermeable membrane comprising providing a polyfunctional amine solution on a substrate to form a polyfunctional amine layer; providing a polyfunctional acid halide solution; and bringing the polyfunctional acid halide solution into contact with the polyfunctional amine layer to form a polyamide film having an upper and a lower surface; wherein nanotubes are dispersed either in the polyfunctional amine solution or in the polyfunctional acid halide solution or in both solutions before bringing the solutions into contact with each other; wherein the nanotubes are added to the solution in a concentration that avoids formation of nanotube structures that extend along the entire thickness of the polyamide film between the upper and the lower surface.

In one method, the substrate on which the polyamine layer can be formed is a microporous substrate. The microporous substrate can have, for example, an asymmetric structure along the cross-sectional direction.

The microporous substrate may be prepared by any method known to a person skilled in the art. In one example, the microporous substrate is prepared by phase inversion method. Phase inversion method for obtaining polymer films or layers is carried out as described above.

The microporous substrate may for example have micropores of which average pore size at the surface of the substrate is 2 to 500 nm. The microporous substrate may for example have a thickness of 10 to 300 μm.

The microporous substrate can be made by any suitable polymer. Examples of such polymers can be polyethersulfones, polyphenylenesulfones, polyphenylenesulfidesulfones, polyacrylonitriles, cellulose esters, polyphenyleneoxides, polypropylenes, polyvinylchlorides, polyarylsulfone, polyphenylene sulfone, polyetheretherketone or polysulphone.

The concentration of the polymer in the microporous substrate may depend upon the polymer used. In general, the concentration of the polymer may be about 10 to 40 wt %. For polysulone polymer, the concentration of polysulfone in the microporous substrate may be for example between about 10 to about 30 wt %.

In one method, the polymer is dissolved in a solvent and can be cast on a smooth surface such as for example glass or stainless steel, aluminium, aluminium alloy, iron, plastics such as Polytetrafluoroethylene (PTFE), Polypropylene (PP), Polyethylene (PE), PolyvinylChloride (PVC), Acrylonitrile Butadiene Styrene (ABS), Polyamide (PA), polyoxymethylene (POM), polycarbonate (PC), polyphenylene oxide (PPO), Polyester (PET), Polyethylene terephthalate (PETE).

The solvents used to dissolve the polymer may be for example acetone, chloroform, dimethylformamide, dimethyl sulfoxide, dimethylacetamide, N-methylpyrrolidone, tetrahydrofuran or mixtures thereof. The cast can then be immersed in a coagulation bath containing a solvent.

The coagulation bath may contain water or a mixture of water and an additive as a solvent. The additive is selected from the group acetone, chloroform, dimethylformamide, dimethyl sulfoxide, dimethylacetamide, N-methylpyrrolidone, tetrahydrofuran or mixtures thereof. In one embodiment, the support on which the polymer solution is cast may be immersed in the coagulation bath after evaporating the solvent for a prescribed time. In this case, the time for evaporating the solvent may be between about 0 to about 60 min. In one example, the evaporating time may be between about 0 to about 10 min, about 0 to about 6 min.

The microporous substrate thus obtained may be washed with water so as to exchange the solvent in the substrate for water.

In one example, the microporous substrate may be reinforced on a support layer. The support layer according to an illustrative example may be, for example a woven fabric or non-woven fabric. The woven or non-woven fabric can be made, for example of polyesters, polypropylenes, polyamides, polyacrylonitriles, regenerated celluloses or acetyl-celluloses.

In one example, providing polyfunctional amine solution on a substrate means coating an aqueous solution containing polyfunctional amine to a porous polymer substrate.

In one example, providing a polyfunctional amine solution on a substrate to form a polyfunctional amine layer may be by immersing the substrate in an aqueous polyfunctional amine solution for about 1 to about 10 minutes and then removing the substrate from the solution. The liquid droplets on the surface of the substrate can be removed by methods known to person skilled in the art, such as for example by evaporation or roll by rubber roller.

In another example, the polyfunctional amine can be, for example, an aliphatic, aromatic, heterocyclic, alicyclic compound having more than two or more primary or secondary amino groups in one molecule or mixtures thereof.

In one example, the polyfunctional amine can be, for example an aliphatic amine. The aliphatic amine can be, for example 1,2-ethanediamine, 1,4-cyclohexanediamine, 1,3-cyclohexane-bismethylamine, polyethyleneimine, N,N-dimethylethylenediamine or mixtures thereof.

In one example, the polyfunctional amine can be, for example an aromatic compound, such as m-phenylenediamine, p-phenylenediamine, 1,3,5-triaminobenzene, or mixtures thereof.

In another example, the polyfunctional amine can be heterocyclic compound. The heterocyclic compound can be, for example piperazine, 2-methylpiperazine or mixtures thereof. In one embodiment, the polyfunctional amine is dissolved in a solvent to form a solution, for example an aqueous solution. In one example, the polyfunctional amine is dissolved in water.

In an example, the concentration of polyfunctional amine in the solution in a concentration between about 0.5 to about 5 wt % of the total solution.

In another example, providing polyfunctional acid halide solution means mixing or dissolving polyfunctional acid halide in a solvent.

In another example, the polyfunctional acid halide can be, for example an aliphatic, aromatic, heterocyclic, or alicyclic compound having two or more halide groups in one molecule or mixtures thereof.

In one embodiment, the polyfunctional acid halide can be an aromatic compound, such as isophthaloyl chloride, terephthaloyl chloride, trimesoyl chloride, 1,2,4-benzentricarboxylic acid trichloride or mixtures thereof.

In another example, the polyfunctional acid halide can be adipoyl dichloride.

In one example, the polyfunctional acid halide can be an alicyclic compound, such as tetra-substituted acyl chlorides of cyclopentane tetracarboxylic acid and cyclobutane tetracarboxylic acid; namely 1,2,3,4-cyclopentane tetracarboxylic acid chloride and 1,2,3,4-cyclobutane tetracarboxylic acid chloride and the tri-substituted acyl chlorides of cyclopentane tricarboxylic acid and cyclobutane tricarboxylic acid, namely, 1,2,4-cyclopentane tricarboxylic acid chloride and 1,2,3-cyclobutane tricarboxylic acid chloride or mixtures thereof.

In one example the solvent for dissolving polyfunctional acid halide can be a saturated aliphatic hydrocarbons or alicyclic hydrocarbons. Other solvents can include chlorofluorocarbon such as trichlorotrifluoroethane.

The aliphatic hydrocarbon solvents can be for example n-hexane, n-octane, n-nonane, n-decane, n-undecane, n-dodecane or mixtures thereof.

In one example, the solvent is an alicyclic hydrocarbon, such as cyclooctane or ethylcyclohexane or mixtures thereof. In another example, polyfunctional acid halide is comprised in the solution in a concentration between about 0.01 to about 1 wt % of the total solution.

The nanotubes can be dispersed either in a polyfunctional amine solution or in a polyfunctional acid halide solution or both before bringing the solutions in contact with each other.

The nanotubes, for example the concentration, modification, length of the nanotubes as described above applies and may be used for the method of preparing composite semipermeable membrane by interfacial polymerization method of the present invention.

According to an example, the concentration of nanotubes to a polyfunctional amine solution or polyfunctional acid halide solution or both solutions may be in a concentration between about 0.001 to about 10 wt %.

In another example, the concentration of nanotubes to a polyfunctional amine solution or polyfunctional acid halide solution or both solutions may be in a concentration solution between about 0.01 to about 10 wt %, or between 0.001 to about 5% or between about 0.001 to about 4 wt %, or between 0.001 to about 3 wt %, or between 0.001 to about 2 wt %.

In another example, the concentration of nanotubes to a polyfunctional amine solution or polyfunctional acid halide solution or both solutions may be in a concentration solution between about 0.01 to about 10 wt %, or between 0.001 to about 5% or between about 0.001 to about 4 wt % or between 0.001 to about 3 wt %, or between 0.001 to about 2 wt % for a Type 2 RO membrane.

The surfactant used in the methods of the present invention can be an amphoteric surfactant, anionic surfactant, cationic surfactant or nonionic surfactant.

The anionic surfactant can be sodium dodecyl sulfate (SDS), sodium pentane sulfonate, dehydrocholic acid, glycolithocholic acid ethyl ester, ammonium lauryl sulfate and other alkyl sulfate salts, sodium laureth sulfate, alkyl benzene sulfonate, soaps or fatty acid salts.

The nonionic surfactant can be a alkyl poly(ethylene oxide), diethylene glycol monohexyl ether, copolymers of poly(ethylene oxide) and polypropylene oxide), hexaethylene glycol monohexadecyl ether, alkyl polyglucosides, digitonin, ethylene glycol monodecyl ether, cocamide MEA, cocamide DEA, cocamide TEA or fatty alcohols.

The cationic surfactant can be, for example cetyl trimethylammonium bromide (CTAB), dodecylethyldimethylammonium bromide, cetylpyridinium chloride (CPC), polyethoxylated tallow amine (POEA), hexadecyltrimethylammonium p-toluenesulfonate, benzalkonium chloride (BAC), or benzethonium chloride (BZT).

The amphoteric surfactant can be dodecyl betaine, sodium 2,3-dimercaptopropanesulfonate monohydrate, dodecyl dimethylamine oxide, cocamidopropyl betaine, 3[N,N-dimethyl(3-palmitoylaminopropyl)ammonio]-propanesulfonate or cocoampho glycinate.

The nanotube dispersion can be applied to the surface of the substrate comprising the polyfunctional amine layer and left for about 1 to about 20 min where interfacial co-polymerization takes place at the interface between the two solutions resulting in the formation of polyamide thin film or layer. The solvent remaining on the surface of the substrate can be evaporated.

The thus prepared composite membrane can be washed with flowing water for about 10 min to about 50 min to remove the non-reacted acid chloride. A curing process is then applied to the thus prepared composite membrane in hot water or air from about 60° C. to about 90° C.

Thus, the present invention provides a composite semipermeable membrane comprising a polyamide film having an upper and lower surface; wherein the polyamide film comprises nanotubes dispersed therein, wherein the nanotubes do not extend along the entire thickness of the polyamide film between the upper and the lower surface; the polyamide film being arranged on a substrate.

In one example, a method of the present invention provides a Type 2 RO membrane by interfacial polymerization method.

FIG. 3 shows Type 2 RO membrane (3) formed by interfacial polymerization method cast on a substrate (16) with a support layer (14). The rod like structures (12) which can be seen within the membrane polymer film (18) symbolize the nanotubes (12) dispersed in the polymer membrane film (18).

In one example, the substrate is a microporous substrate as previously described.

The semipermeable membranes as herein described may be formed into a flat sheet or a hollow fiber or tube.

The semipermeable membranes of the present invention may be used in separation of liquids by osmotic processes. The osmotic processes include reverse osmosis and forward osmosis.

The composite or polymeric semipermeable membrane of the present invention, can be used for the separation of H₂O from solute.

The composite or polymeric semipermeable membrane of the present invention can be widely adopted for liquid separation in wide range of industries including pharmaceutical, food, and water.

For example, the semipermeable membranes according to the present invention can be used for desalination or water reclamation or brine treatment or wastewater treatment or food processing or the operation of osmotic pumps, or power generation via pressure retarded osmosis, or concentration of dilute industrial water or concentration of landfill leachate, or direct potable reuse for life support systems, or concentration of digested sludge liquids (Cath, T. Y., Childress, A. E., Elimelech, M., 2006, supra).

By “comprising” it is meant including, but not limited to, whatever follows the word “comprising”. Thus, use of the term “comprising” indicates that the listed elements are required or mandatory, but that other elements are optional and may or may not be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### EXAMPLES

### Materials

Cellulose acetate (CA, M_{N} ca.30000, 39.8 wt % acetyl content) was purchased from Sigma-Aldrich as a membrane material. Formamide (Sigma-Aldrich, USA), acetone (Merch, Germany) and NaCl (Merch, Germany) of analytical grade were used as received. In one example, carbon nanotubes (short multi-walled carbon nanotubes, MWNT, manufactured by CVD process and supplied by Chengdu Organic Chemicals Co., Ltd., China), whose purity is greater than 95%, were used for the preparation of the composite FO membrane. The MWNT is in tubular shape having an outer diameter of, for example, between about 30-50 nm and a length of between about 0.5-2 μm. In one example, those nanotubes were modified by supplier to contain 5.58 wt % OH content on surface, and shortened to 0.5-2 μm length for two-ends opened tubes. Having both ends open ensures that flow of liquid through the nanotube is possible.

### FO Membrane

### Fabrication of FO Membrane

Appropriate amount of MWNT (the multi walled carbon nanotubes (MWNT) was supplied by Chengdu Organic Chemicals Co., Ltd., China. The purity of the nano-tubes was greater than 95%, and the outer diameter of each carbon nano-tube is about 30-50 nm. According to our requirements, the MWNT were modified to contain 5.58 wt % OH content and shortened to 0.5-2 μm in length to make both ends of each nanotube open) was dispersed into 24 g of acetone and formamide mixture (weight ratio of acetone to formamide at 2.5 to 1) to prepare MWNT solutions of different MWNT content. For example, 0.012 g of MWNTs was dispersed into 24 g of acetone-formamide mixture to prepare a MWNT solution which will eventually produce an FO membrane of 0.2 wt % (% weight of nano-tubes to weight of CA polymer). To produce 0.5, 1.0, 2.0, 3.0 and 4.0 wt % (weight of nano-tubes to CA polymer) forward osmosis membrane, 0.03, 0.06, 0.12, 0.18 and 0.24 g of MWNT, respectively, was added to a 24 g acetone-formamide mixture to form different MWNT solutions. For better dispersion of the MWNTs in acetone and formamide mixture, each MWNT solution was sonicated for 10 min in an ultrasonic bath (sonicskorea, SKB-2000, 2 kW). 6 g of cellulose acetate (CA) was added to each MWNT solution and then mixed with stirring at room temperature to prepare the CA/MWNT blend solutions of different MWNTs contents. For all the CA/MWNT blend solutions, CA to acetone-formamide mixture ratio was 20/80. Subsequently, the CA/MWNT blend solutions (casting solutions) were kept at room temperature for at least 24 h to remove air bubbles from the solutions. The casting solutions were then cast at 120 μm thickness using a RK control coater (K202, R K print coat instruments Ltd). Without further evaporation, the membranes were immediately immersed in a coagulation bath (water) for 2 h at 0-4° C. The membranes were then annealed for 20 rain at 80° C. The prepared membranes were then washed with pure water for at least 24 h before test.

### Membrane Characterization

Images of membrane cross-section were obtained using TEM (JEOL JEM 2010F HRTEM). Membrane samples were prepared for TEM imaging by embedding small pieces of the membrane into the polymer resin. Approximately 70 nm thick sections were cut on Microtomes and placed on Formvar-coated copper grids. The sections were examined at an accelerating voltage of 200 kV.

The surface roughness of the membranes was measured by AFM (Digital instruments NanoScope™ Scanning Probe Microscope, Veeco Metrology Group). Tapping mode was used to scan the surface, which eliminates shear forces that can damage soft samples and reduce the image resolution.

The membrane Xray Diffraction (XRD) patterns were recorded on a) (RD-6000, ShiMadzu using Cu K_{α} radiation (λ=0.15418 nm) at a scan rate of 2°/min.

Thermogravimetric analysis (TGA) was performed on membranes by using TGA2050, TA instrument from room temperature to 550° C. at a heating rate of 10° C./min with a nitrogen flow rate of 200 ml/min.

The breaking strength of the membranes was examined to investigate the mechanical stability using Instron Micrometer 5564 at a loading velocity of 2 min/min.

The surface (Zeta) potential of membranes was determined by measuring the streaming potential (Anton Paar Electro Kinetic Analyzer, Australia) with 10 mM NaCl solution at unadjusted pH (˜5.8).

### FO Experimental Setup

Performance of the membranes was evaluated in terms of pure water flux and solute rejection in a laboratory forward osmosis crossflow set-up (as shown in FIG. 8).

The specially designed cross-flow membrane cell (100) has a channel on each side of the membrane (104), which allows the feed (116) and draw (118) solutions to flow through separately. Each channel has dimensions of 4, 100, and 40 mm for channel height, length, and width, respectively. Cocurrent flow was used with flow rate in each channel controlled by a centrifugal pump (106) (Cole-Panner, U.S.A.) and monitored with a flow meter (108) (Blue-white Industries Ltd., U.S.A.). The cross-flow rates for the feed and draw solution were both maintained at 2.0 L*min⁻¹ (equivalent to 8.34 cm*s⁻¹). Heaters were used to maintain the temperature of the feed (116) and draw (118) solutions homogenously at 25° C. The solutions were stirred to keep them homogenous by stirrer (120). A weighing scale (112) (SB16001, Mettler Toledo, Germany) connected to a computer (114) was used to monitor the weight of water permeating through the membrane from the feed to the draw side, from which the water flux was calculated. In the experiments, 2.0M NaCl solution was used as the draw solution and deionized water as the feed solution. All membranes were tested in the orientation of the dense selective side facing the draw solution.

The water flux was calculated from the changes in the weight of the draw solution during each experimental run. As water permeated through the membrane from the feed to the draw side, the weight of the draw solution increased with time. Water flux (Jw) can then be calculated [1]:

$${J}_{W} = \frac{Δ \text{Weight}}{\text{Water Density × Membrane Surface Area × Δ Time}} \qquad ( 1 )$$

To determine the NaCl rejection, a sample of feed solution was taken after a complete FO run and measured the chloride concentration using a chloride selective electrode (6560-10C, Horiba, Kyoto, Japan). Based on the amount of water passed into the draw solution over the course of the experiment and the final amount of NaCl in the feed solution, the permeate NaCl concentration is determined. The percent salt rejection, R, is then calculated from

$$R = ( 1 - \frac{{C}_{p}}{{C}_{d}} ) \times 100 \% \qquad ( 2 )$$

where Cp and Cd are permeate and draw NaCl concentrations, respectively.

### RO Membrane

### Fabrication of the RO (Type 1) Membrane:

Appropriate amount of MWNT was dispersed into 30 g of acetone and formamide mixture (weight ratio of acetone to formamide at 2 to 1) to prepare MWNT solutions of different MWNT content. For example, 0.02 g of MWNTs was dispersed into 30 g of acetone-formamide mixture to prepare a MWNTs solution which will eventually produce an RO membrane of 0.2 wt % (% weight of nano-tubes to CA polymer). To produce 0.5, 1.0, 2.0, 3.0 and 4.0 wt % (weight of nano-tubes to CA polymer) RO membrane, 0.05, 0.1, 0.2, 0.3 and 0.4 g of MWNT, respectively, was added to a 30 g acetone-formamide mixture to form different MWNT solutions. For better dispersion of the MWNTs in acetone, each MWNT solution was sonicated for 10 min in an ultrasonic bath (sonicskorea, SKB-2000, 2 kW). 10 g of CA was added to each MWNT solution and then mixed with stirring at about 60° C. to prepare the CA/MWNT blend solutions of different MWNTs contents. For all the CA/MWNT blend solutions, CA to acetone-formamide mixture ratio was 25/75. Subsequently, the CA/MWNT blend solutions (casting solutions) were kept at about 60° C. for at least 24 h to remove air bubbles from the solutions. The casting solutions were then cast at 250 μm thickness using a RK control coater (K202, R K print coat instruments Ltd). Without further evaporation, the membranes were immediately immersed in a coagulation bath (water) for 2 h at 0-4° C. The membranes were then annealed for 20 min at 80° C. The prepared membranes were washed with pure water for at least 24 h before test.

### Fabrication of RO (Type II) Membrane

0.004% w/v of nano-tubes was dispersed in a solution of trimesoyl chloride (0.1% w/v in hexane) in advance. Nano-tubes dispersion was obtained by ultrasonication for 1 h at room temperature immediately prior to interfacial polymerization. The polysulfone microporous substrate (self-made or purchased) was immersed in an aqueous m-phenylenediamine solution (concentration: 2.0% w/v) for 2 min and then taken out from the solution. After removing the liquid drops on the surface of the substrate, the substrate was immersed into the solution of trimesoyl chloride containing nano-tubes for 1 min, during which interfacial copolymerization took place at the interface between the two solutions that resulted in the formation of a polyamide thin film. After 1 min reaction, the substrate was removed from the solution to allow the remaining solvent on the surface of the substrate to be evaporated for about 1 min. The thus prepared composite membrane is washed with flowing water for 50 min to remove the non-reacted acid chloride. A curing process is then applied to the thus prepared composite membrane in hot water at 70° C. for 5 min.

### Testing of RO Membranes

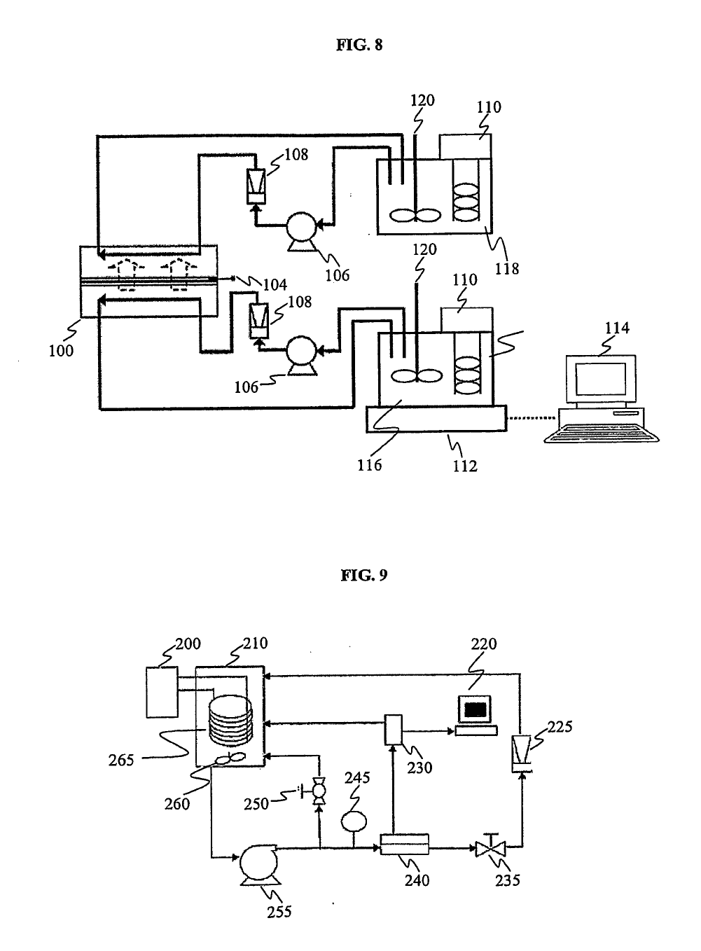

The RO membrane was housed in a crossflow membrane cell (240), which was part of the RO filtration unit shown in FIG. 9. The feed water in the feed tank (210) was cooled in a chiller (200) and circulated into the membrane cell by a diaphragm pump (265) (Hydra-cell D-03, Wanner Engineering, Inc., Minneapolis, Minn.). The feed solution was kept homogenous by stirring using a stirrer (260). Desired pressure and feed flow rate were achieved by adjusting the bypass needle valve (250) and back-pressure regulator (235). The applied pressure and retentate flowrate were monitored by a digital pressure gauge (245) (PSI-Tronix, Inc., Tulane, Calif.) and a variable area flow meter (225) (Blue-White industries, Ltd., Huntington Beach, Calif.), respectively. The permeate flow rate was measured by a digital flow meter (230) (Optiflow 1000, Agilent Technologies, Plo Alto, Calif.) that was linked to a personal computer (220) for continuous logging and monitoring. Permeate and retentate were recycled back to the feed tank. Feed water in the polyethylene tank was magnetically stirred and maintained at 25±0.5° C. by a chiller (Model CWA-12PTS, Wexten Precise Industries Co., Taiwan).

Separation performance of the RO membranes was evaluated in terms of pure water flux and salt rejection in the RO setup described above. The effective membrane area was 30 cm². The pure water flux was measured at room temperature (˜25° C.) after the membranes were compressed for 3 h at 250 psi. The salt rejection test was then carried out with 2000 ppm aqueous solutions of NaCl at the same pressure. After 6 h operation, the salt rejection was calculated from

$$R = ( 1 - \frac{{C}_{p}}{{C}_{d}} ) \times 100 \% \qquad ( 3 )$$

where Cp and Cd are permeate and feed NaCl concentrations, respectively. At the same time, the water flux was measured for the salt solution.

### Results

The distribution of MWNT in the CA membrane is shown in the transmission electron microscopy (TEM) images which are presented in FIG. 13. Few MWNT aggregated into clusters, but most of them were well dispersed in the CA polymer at low MWNTs (0.2 wt %), as shown in figure (FIGS. 13 (a), (b)). All the discrete tubes possess a highly specific surface, which facilitated the MWNTs/CA interactions. The relatively well dispersed MWNTs in the membrane indicated weak MWNTs/CA interactions which are expected based on the matrix polarity and MWNTs surface chemistry. In addition, the OH group on the surface of MWNT can promote the interactions and these can possibly improve the dispersion of the MWNTs within the membrane polymer matrix. The TEM images (FIG. 13(c)) revealed that when the number of tubes increases with the amount of MWNT content (3.0 wt %), the number of aggregated clusters also increases.

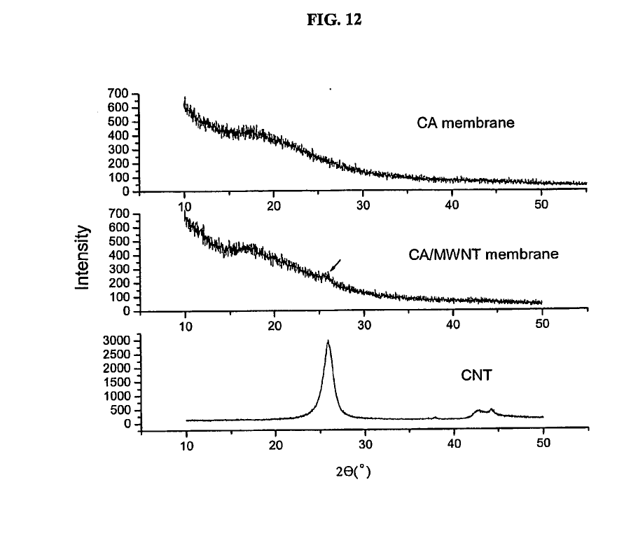

Evidence of the interactions can be found from the XRD diffraction patterns of these membranes. The XRD diffraction patterns of MWNT, CA membrane and CA/MWNT membrane are shown in FIG. 12. The pattern of MWNT crystal had two crystalline characteristic peaks at 2Θ of 26.0°, 43.0°. The pattern of CA/MWNT membrane only showed one weak crystalline characteristic peak analogous with and slight shift from the characteristic peak of MWNT crystal at 2Θ of 26.0°. The weak peak at 26.0° and loss of peak at 43.0° were ascribed to thinner membrane (150 μm) and lower contents of MWNT in the membranes. The shift of characteristic peak of MWNT in CA/MWNT membrane possibly indicates the interactions between polymers and MWNT.

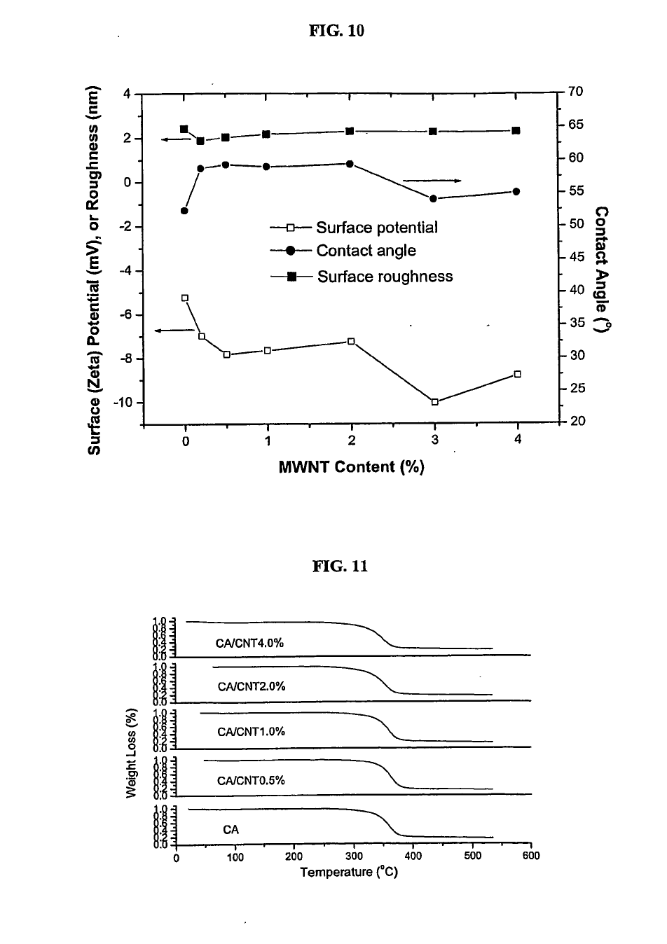

Measured values of CA/MWNT membrane surface roughness, water contact angle, and surface (zeta) potential are plotted in FIG. 10. As MWNT loading increased, the contact angle slightly increased from 52.36° for CA membrane without nanotubes to 58.69° for 0.2% MWNTs content, which may possibly be caused by the migration of hydrophilic MWNT to the membrane surface due to the lower viscosity of the cast solution during the membrane formation process. However, at higher content of MWNT (4%), the contact angle slightly decreased to 55.03° because fewer MWNT migrate to the membrane surface due to the more viscous cast solution as well as the aggregation of MWNT. Although the addition of MWNTs increased slightly the water contact angle for the membrane surfaces, it should have minimal impact on the hydrophilicity of the membrane surface. Both the surface roughness and surface potential decreased with addition of MWNT. This means that CA/MWNT membranes become smoother and more negatively charged compared with CA membrane, which are beneficial to better water permeability and higher salt rejection.

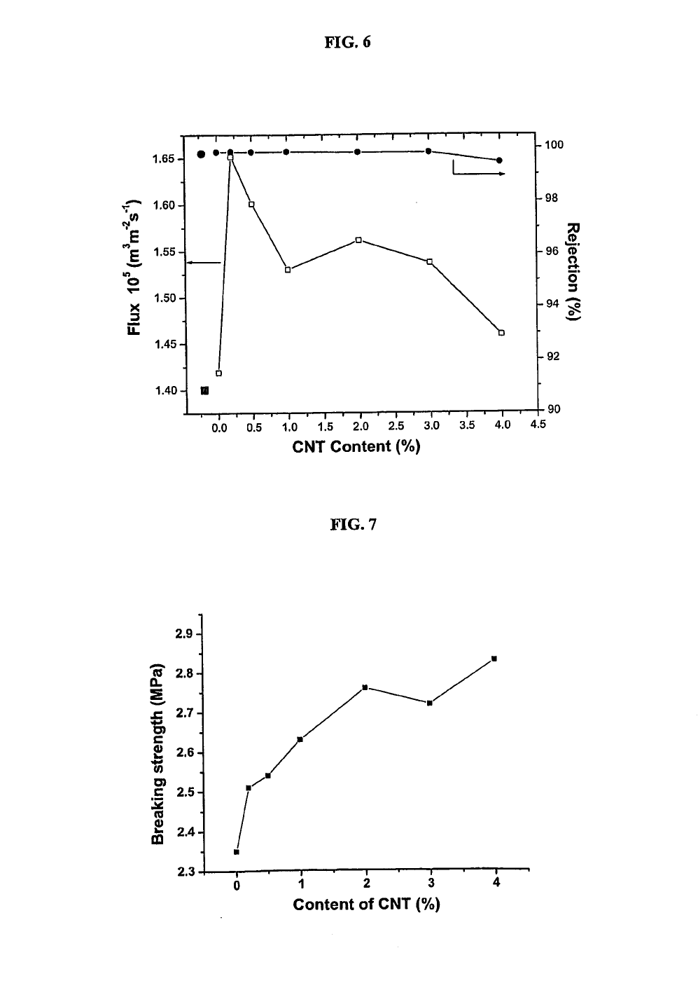

In order to investigate the effects of MWNT on the permeability and rejection of the FO membranes without considering the influence of internal concentration polarization, FO experiments were conducted using deionizer water as the feed solution. (J. R. McCutcheon, R. L. McGinnis, M. Elimelech, 2006, J. of Membr. Sci., vol. 278, p. 114; J. R. McCutcheon, M. Elimelech, 2006, J. Membr. Sci., vol. 284, p. 237). As shown in FIG. 5, the permeability of the membrane increased firstly and then decreased with the increase of MWNT content and reached a maximum of 35.02 GFD when MWNT content was 0.2 wt. %. Table 1 illustrates the flux (GFD) and percentage solute rejection of the membrane incorporating nanotubes at various percentage concentration and a prior art membrane as illustrated in the graph shown in FIG. 5. From the table, it can be found that the flux increases with the incorporation of the nanotubes with high salt rejection percentage when compared to the prior art membrane.

TABLE 1

| CNT content | Flux (GFD) | Rejection (%) |
|---|---|---|
| Prior Art | 29.69 | 99.81 |
| Membrane | | |
| 0.0 | 30.09 | 99.85 |
| 0.2 | 35.02 | 99.86 |
| 0.5 | 33.95 | 99.85 |
| 1.0 | 32.45 | 99.86 |
| 2.0 | 33.11 | 99.83 |
| 3.0 | 32.59 | 99.82 |
| 4.0 | 30.94 | 99.45 |

The improvement on the water flux was probably due to the change in the thermodynamic property of the casting solution after the addition of MWNT, which consequently affected the kinetics of the membrane formation process. Beneficially, addition of MWNT may improve the membrane's permeability resulting in increased porosity and decreased pore size. However, higher MWNT content (≧0.5 wt %) would increase the viscosity, of the casting dispersion, which would retard the exchange of solvent (acetone) and non-solvent (water), e.g. slowed down the formation process of CA/MWNT membrane. As a result, a thicker skin layer would be formed, which can reduce water permeability but still allows functioning of the membrane. Some of the tubes, e.g. those vertical to the membrane surface (as shown in FIG. 13 (b)), as well as those well dispersed in the membrane, may play an active role in attracting water molecules into tubes and promote water passage through the membrane and thus enhance the permeability. Solute rejections for all membranes were more than 99% after a specified operation time (2 h). The rejection changed slightly with the increase of MWNT content and reached a maximum at 0.2 wt % MWNT. The smaller pores and thicker skin layer caused by the addition of MWNT may have a positive effect on rejection. However, at higher MWNT concentration (>4.0 wt %), the formation of large pores on the membrane surface caused by MWNT aggregation (FIG. 13 (c)) resulted in the decline in solute rejection.
Table 2 shows the flux of the RO membrane Type 1 membrane and its salt rejection with different nano-tube content. The test was operated in a self-made high-pressure cross-flow cell; the pure water flux was measured at 25° C. after the membranes were compressed for 3 h at 250 psi (about 1723.69 kPa); the salt rejection and water flux test was then carried out with 2000 ppm aqueous solution of NaCl at the same pressure and temperature after 6 h. The water crossflow rate is 0.4 L/min.

TABLE 2

| | Pure | Water flux in 2000 ppm | |
|---|---|---|---|
| Content of CNT | water flux | NaCl solution | Salt rejection |
| (%) | (GFD) | (GFD) | (%) |
| 0.0 | 6.45 | 5.44 | 88.46 |
| 0.2 | 8.00 | 7.03 | 91.54 |
| 0.5 | 8.05 | 7.15 | 90.13 |

As shown in Table 2, the permeability of the RO membrane increased with the increase of MWNT content and reached 8.05 GFD (pure water feed) and 7.15 GFD (2000 ppm NaCl feed) when MWNT content was 0.5 wt %. The salt rejection also increased slightly with the increase of MWNT content and reached a maximum at 0.2 wt % MWNT. A possible reason for the improvement on the water flux and salt rejection was discussed in above section of FO membrane.

The mechanical strength of membranes used in the FO process is another membrane parameter, especially for PRO applications, where the membrane is required to sustain hydraulic pressure. Enhancing the membrane strength is preferred if thinner FO membranes with low ICP are to be manufactured. The testing results of mechanical strength (breaking strength) are given in FIG. 7. It can be observed that the mechanical strength of membrane was enhanced with the increase in MWNT content. This is because the addition of MWNT led to the increase in viscosity of casting solution, which resulted in a thicker skin layer and the suppression of the formation of macrovoids, all of which contributed to the increase in the mechanical strength of membrane. In addition, a significant reason for the increase in the mechanical strength of the membrane can also be attributed to the reinforcement effect of the finely dispersed high-performance MWNT throughout the polymer matrix, and the interaction between MWNT and polymer matrix due to the interaction between CA chains and OH groups on the surface of MWNT. The OH groups play an important role for improving the dissolubility of MWNT in polar solvent. Cellulose acetate, a hydrophilic polymer, which also possesses OH groups, can form a strong hydrogen-bond with the MWNT. The compatibility and interaction between MWNT fillers and the matrix greatly enhances the dispersion as well as the interfacial adhesion, thus increasing the mechanical properties of the matrix. Hydrophilic groups, such as —OH or —COOH can also contribute to a higher water flow through the nanotube and can avoid that ions are passing through the nanotubes.

FIG. 11 shows TGA curves of the CA/MWNT membranes with various concentrations of MWNT, at a heating rate of 20° C./min with N₂ gas purging. The TGA curves shows that CA degraded in three steps, which corresponded to the three thermal degradation steps of the cellulosic materials (P. K. Chatterjee, C. M. Conrad, Thermogravimetric Analysis of Cellulose, J. Polym. Sci. Part A-1: Polym. Chem., 6 (1968), 3217-3233; A. A. Hanna, A. H. Basta, H. El-Saied, I. F. Abadirl, Thermal properties of cellulose acetate and its complexes with some transition metals, Polym. Degrad. Stab., 63 (1999), 293-296). The second step starts at about 330° C. and ends at 500° C., and represents the main thermal degradation of the cellulose acetate chains. The start temperature of degradation can be used to qualitatively characterize the thermal stability of materials. From the FIG. 12, it can be seen that all curves showed similar profile, e.g. the membranes with different MWNT contents have similar thermal stability. That means that small quantities of MWNT in CA matrix do not affect the thermal stability of CA membrane significantly.

Described herein are polymeric or composite FO and RO (Type 1 and Type 2) membranes comprising MWNTs incorporated into a polymer which have been prepared by a phase inversion method and interfacial polymerization method. The FO membranes exhibited simultaneous increase of water permeability and solute rejection compared to similarly formed FO (see FIG. 5) and RO (Type 1 (FIG. 6) and Type 2) membranes without nanotubes. The permselective properties of the polymeric or composite FO and RO (Type 1 and Type 2) membranes were observed to be dependent on the content of the MWNTs used. By varying the membrane preparing process and for MWNTs content, it was possible to change the separation performances of the polymeric or composite FO and RO (Type 1 and Type 2) membranes for different application, such as desalination of seawater or brackish water. At the same time, the mechanical strength of the polymeric or composite membranes is also enhanced, while the thermal stability is kept almost unchanged.

Composite or polymeric FO membranes showed about 16.38% improvement in water permeability and as much as 40% when 0.5M NaCl feed solution was used, with almost unchanged solute rejection. However, at higher MWNT content, the improvements to performance were lower which may be attributed to MWNTs aggregation, i.e. cluster formation.

In one example, composite RO membranes showed about 24.81% water flux (using pure water feed), or 31.43% (using 2000 ppm NaCl feed), and salt rejection increase is 3.48%.

The composite or polymeric FO and RO (Type 1 and Type 2) membrane incorporated with MWNTs is of great significance for the rational design of novel semipermeable membranes, for the substantial expansion of carbon nanotube applicability. The simultaneous increase of separation and mechanical properties can greatly extend the application of FO and RO (Type 1 and Type 2) membranes, such as in the field of pressure retarded osmosis.

1. A method of manufacturing a polymeric semipermeable membrane, wherein said method comprises:
dispersing nanotubes in a polymer solution to obtain a nanotube-polymer dispersion;
casting a membrane having an upper and lower surface with said dispersion by phase inversion method; and
wherein said nanotubes are added to said polymer solution in a concentration of nanotubes to polymer in said polymer solution that substantially avoids formation of nanotube structures that extend along the entire thickness of said membrane between said upper and said lower surface.

2. The method according to claim 1, wherein said membrane is casted on a support layer.

3. The method according to claim 2, wherein said membrane support layer is a fabric support layer; or wherein said membrane support layer is a fabric support layer which is a woven or non-woven fabric.

4. (canceled)

5. The method according to claim 1, wherein said polymer in said polymer solution is selected from the group consisting of cellulose based polymers.

6. The method according to claim 1, wherein said membrane has a thickness between about 10 to 400 μm.

7. The method according to claim 1, wherein said polymer is dissolved in a solvent to form said polymer solution; or wherein said polymer is comprised in said solution in a concentration between about 10 to 40 wt %.

8. (canceled)

9. (canceled)

10. A method of manufacturing a composite semipermeable membrane, wherein said method comprises:
providing a polyfunctional amine solution on a substrate to form a polyfunctional amine layer on said substrate;
providing a polyfunctional acid halide solution; and
bringing said polyfunctional acid halide solution into contact with said polyfunctional amine layer to form a polyamide film having an upper and a lower surface;
wherein nanotubes are dispersed either in said polyfunctional amine solution or in said polyfunctional acid halide solution or in both solutions before bringing said solutions into contact with each other;
wherein said nanotubes are added to said solution(s) in a concentration that substantially avoids formation of nanotube structures that extend along the entire thickness of said polyamide film between said upper and said lower surface.

11. The method according to claim 10, wherein said substrate is a polymeric microporous substrate; or wherein said substrate is a polymeric microporous substrate which is selected from the group consisting of polyethersulfones, polyphenylenesulfones, polyphenylenesulfide sulfones, polyacrylonitriles, cellulose esters, polyphenyleneoxides, polypropylenes, polyvinylchlorides, polyarylsulfone, polyphenylene sulfone, polyetheretherketone, polysulfone and mixtures thereof.

12. (canceled)

13. The method according to claim 10, wherein said substrate is arranged on a fabric support layer or wherein said substrate is arranged on a fabric support layer, wherein the fabric support layer is a woven or non-woven fabric.

14. (canceled)

15. The method according to claim 1, wherein said nanotubes are hydrophobic; or wherein the surface of said nanotubes is modified to carry hydrophilic groups.

16. (canceled)

17. The method according to claim 1, wherein said concentration of nanotubes to polymer in said polymer solution is between about 0.001 to about 10 wt %.

18. The method according to claim 10, wherein said nanotubes are added to said solution(s) in a concentration between about 0.001 to about 10 wt. % or between about 0.01 to about 10 wt. %.

19. (canceled)

20. The method according to claim 1, wherein said nanotubes are single-walled or double-walled or multi-walled nanotubes; or wherein said nanotubes are made of a material selected from the group consisting of a carbon material, a ceramic, glass, soda-lime glass, borosilicate glass, acrylic glass, isinglass (Muscovy-glass), aluminium oxynitride; a metal, a metal oxide, a polypyrrole and mixtures of nanotube materials made of different of the aforementioned substances.

21. (canceled)

22. (canceled)

23. The method according to claim 1, wherein said nanotubes have a length between about 0.2 μm to about 4 μm.

24. The method according to claim 1, further comprising shortening said nanotubes before dispersing them to obtain nanotubes with a length between about 0.2 μm to about 4 μm and having two open ends.

25. The method according to claim 10, wherein said polyfunctional amine is selected from the group consisting of aliphatic, aromatic, heterocyclic, alicyclic compounds having more than two or more primary or secondary amino groups in one molecule and mixtures thereof; or wherein said polyfunctional amine is dissolved in a solvent to form said polyfunctional amine solution.

26. (canceled)

27. (canceled)

28. The method according to claim 10, wherein said polyfunctional amine is comprised in said solution in a concentration between about 0.5 to about 5 wt % of the total solution.

29. The method according to claim 10, wherein said polyfunctional acid halide is selected from the group consisting of aliphatic, aromatic, heterocyclic, alicyclic compounds having two or more halide groups in one molecule and mixtures thereof.

30. The method according to claim 10, wherein said polyfunctional acid halide is dissolved in a solvent to form said polyfunctional acid halide solution; or wherein said polyfunctional acid halide is dissolved in a solvent which is selected from the group consisting of saturated aliphatic hydrocarbons and alicyclic hydrocarbons.

31. (canceled)

32. The method according to claim 10, wherein said polyfunctional acid halide is comprised in said solution in a concentration between about 0.01 to about 1 wt % of the total solution; or wherein said nanotubes are mixed with a surfactant or a mixture of surfactants before dispersing them.

33. (canceled)

34. The method according to claim 32, wherein said surfactant is selected from the group consisting of amphoteric surfactants, anionic surfactants, cationic surfactants and nonionic surfactants.

35. The method according to claim 1, wherein said dispersion is subjected to sonication; or wherein the nanotubes comprise hydrophilic groups on their surface selected from carboxyl, carbonyl, hydroxyl groups and mixtures thereof; or wherein said membrane is formed into a flat sheet or a hollow fiber or tube.

36. (canceled)

37. (canceled)

38. (canceled)

39. (canceled)

40. (canceled)

41. A composite semipermeable membrane comprising:
an upper and lower surface; wherein said membrane comprises nanotubes dispersed therein, wherein said nanotubes substantially do not extend along the entire thickness of said membrane between said upper and said lower surface.

42. The composite semipermeable membrane according to claim 41, which is arranged on a support layer; or wherein said membrane has a thickness between about 10 to 400 μm.

43. (canceled)

44. A composite semipermeable membrane comprising:
a polyamide film having an upper and lower surface; wherein said polyamide film comprises nanotubes dispersed therein, wherein said nanotubes substantially do not extend along the entire thickness of said polyamide film between said upper and said lower surface;
said polyamide film being arranged on a substrate.

45. The composite semipermeable membrane according to claim 44, wherein said substrate is a polymeric microporous substrate; or wherein said substrate is a polymeric microporous substrate which is polysulfone.

46. (canceled)

47. The composite semipermeable membrane according to claim 44, wherein said substrate is arranged on a fabric support layer; or wherein said membrane is formed into a flat sheet or a hollow fiber.

48. (canceled)

49. A method of osmosis using a membrane according to claim 1, wherein said method of osmosis comprises (i) a method of reverse osmosis wherein the membrane is casted on a support layer; or (ii) a method of forward osmosis.

50. (canceled)

51. (canceled)

52. (canceled)
